(19) United States
(12) Patent Application Publication
(10) Pub. No.: US 2006/0168953 A1
(43) Pub. Date: Aug. 3, 2006

(54) Energy producing buoyancy pump

(76) Inventor: Paul Lynn Carter, Bridgeport, TX (US)

Correspondence Address: PAUL LYNN CARTER, 1516 TIMBERLINE DRIVE, BENBROOK, TX, 76126, US

(21) Appl. No.: 11/046,962

(22) Filed: Jan. 31, 2005

(51) Int. Cl. F16D 31/02

(52) U.S. Cl. 60/392

(57) ABSTRACT

An energy producing buoyancy pump with a reservoir filled with liquid, a housing submersed in the reservoir, two buoyant chambers that act as pistons within the housing, controlling buoyancy of the buoyant chambers by use of an air or gas transfer pump that transfers air or gas between each buoyant chamber. At the start of the cycle the transfer pump will transfer the air or gas from the buoyant chamber that has reached the top of it's stroke to the one that is at the bottom of it's stroke forcing the liquid from the bottom buoyant chamber to the top buoyant chamber. As the bottom buoyant chamber begins it's upstroke it resets the opposite buoyant chamber while forcing the liquid from the top of the housing to be readily available for work.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of energy and more specifically to an energy producing buoyancy pump, that regulates the buoyancy of a chamber to force a liquid for useful work such as turning a turbine.

Many ways of producing electric have been sought in the past, from windmills to hydro-plants and a number of other ways all in which try to capture the raw force of energy around us. Water pumps are used to pump liquid into storage for extra electric needed during peak times. Electric is still largely generated with the burning of fuels. Water pumps currently in use for pumping liquid into storage use more electric pumping the liquid into storage than the electric the liquid generates when released.

### BRIEF SUMMARY OF THE INVENTION

The primary object of the invention is to provide a better source of pumping liquid without the great loss of energy through friction.

Another object of the invention is to provide a better source of energy without the burning of fuels.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an energy producing buoyancy pump comprising: A reservoir such as an old rock quarry filled with liquid such as water, a housing is submersed in the reservoir, that housing contains two buoyant chambers positioned within the housing that act as pistons, a transfer pump that moves air or gas from one buoyant chamber at the top of it's stroke to the other buoyant chamber that is at the bottom of it's stroke, as the air or gas is transferred, liquid in the bottom buoyant chamber is forced to the top buoyant chamber thus causing the bottom buoyant chamber to rise in effect forcing the liquid out from the top of the housing to a turbine that generates electric that is stored in batteries that power the regulator that controls the transfer pump, then the surplus electric is sent to the power company, and the process repeats.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the energy producing buoyancy pump.

FIG. 2 is a perspective view of the buoyant chambers.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

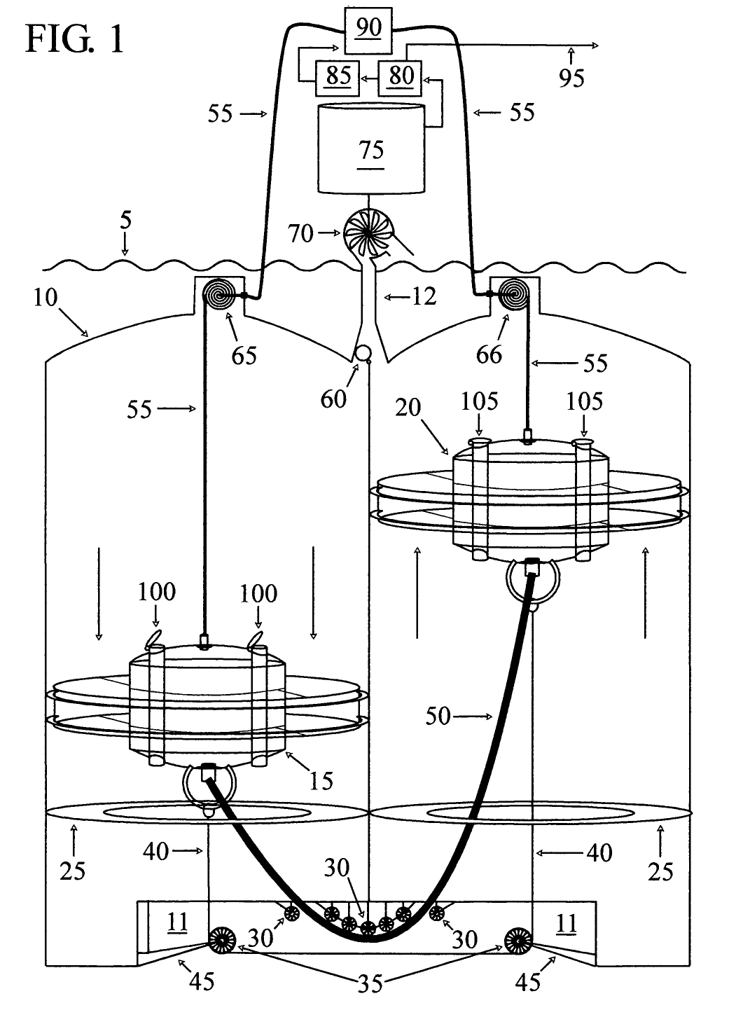

In FIG. 1 there is shown a reservoir 5 filled with liquid, a housing 10 is submersed in said reservoir 5. Housing 10 is shown having an open bottom 11, and a controlled passage 12 at the top. Housing 10 contains two buoyant chambers 15 and 20 positioned within said housing for a vertical stroke movement, buoyant chamber 15 is filled with liquid and shown to be in a down-stroke with internal passage valves 100 open while buoyant chamber 20 is filled with gas or air and shown to be in an up-stroke with internal passage valves 105 closed. Buoyant chambers 15 and 20 are connected by towline 40 to insure a reciprocating motion, towline 40 is being directed by pulleys 35, pulleys 35 are anchored to housing 10 by tie-downs 45. As buoyant chamber 20 rises, it tows buoyant chamber 15 to the bottom by means of towline 40. Also connecting between buoyant chambers 15 and 20 is liquid passage 50 that admits the liquid inside buoyant chambers 15 and 20 to be transferred back and forth. Liquid passage 50 is shown to be guided through rollers 30. Buoyant chamber 15 and 20 are shown being connected to air or gas passage 55. Automatic recoil 65 is uncoiling, and automatic recoil 66 is recoiling. Pivot valve 60 is shown closed on the buoyant chamber 15 side of housing 10, and shown to be open on the buoyant chamber 20 side of housing 10 to admit the liquid out of housing 10 into controlled passage 12 and be readily available for work to turn turbine 70 that turns generator 75 that generates electric to be sent to batteries 80 that stores the electric to be used by regulator 85 to regulate the operation of transfer pump 90 at the beginning of each stroke. Once batteries 80 are fully charged, the surplus of electric is sent through power line 95.

When buoyant chamber 15 reaches the bottom of it's stroke it will rest on stopper 25 stopping buoyant chamber 20 at the top of it's stroke. Then regulator 85 reverses polarity and starts transfer pump 90. Transfer pump 90 then transfers air or gas from buoyant chamber 20 to buoyant chamber 15 through air or gas passage 55, as air or gas transfers to buoyant chamber 15, liquid in buoyant chamber 15 is forced through liquid passage 50 to buoyant chamber 20. As this transfer progresses buoyant chamber 15 will gain buoyancy over buoyant chamber 20 and buoyant chamber 15 will start to rise. As buoyant chamber 15 begins rising it's internal passage valves 100 closes forcing pivot valve 60 to open admitting liquid to escape into controlled passage 12 where liquid will become readily available for work to turn turbine 70 before returning to reservoir 5, turbine 70 turns generator 75, generator 75 generates electric that is sent to be stored in batteries 80, batteries 80 supplies electric for regulator 85 which regulates the operation of the transfer pump 90. At the same time, towline 40 will tow buoyant chamber 20 causing internal passage valves 105 to open and permit liquid to fill the housing, also liquid passage 50 will be guided through rollers 30, and automatic recoil 65 is recoiling while automatic recoil 66 is uncoiling. When batteries 80 are fully charged, the surplus of electric is sent through power line 95 to the local electric company.

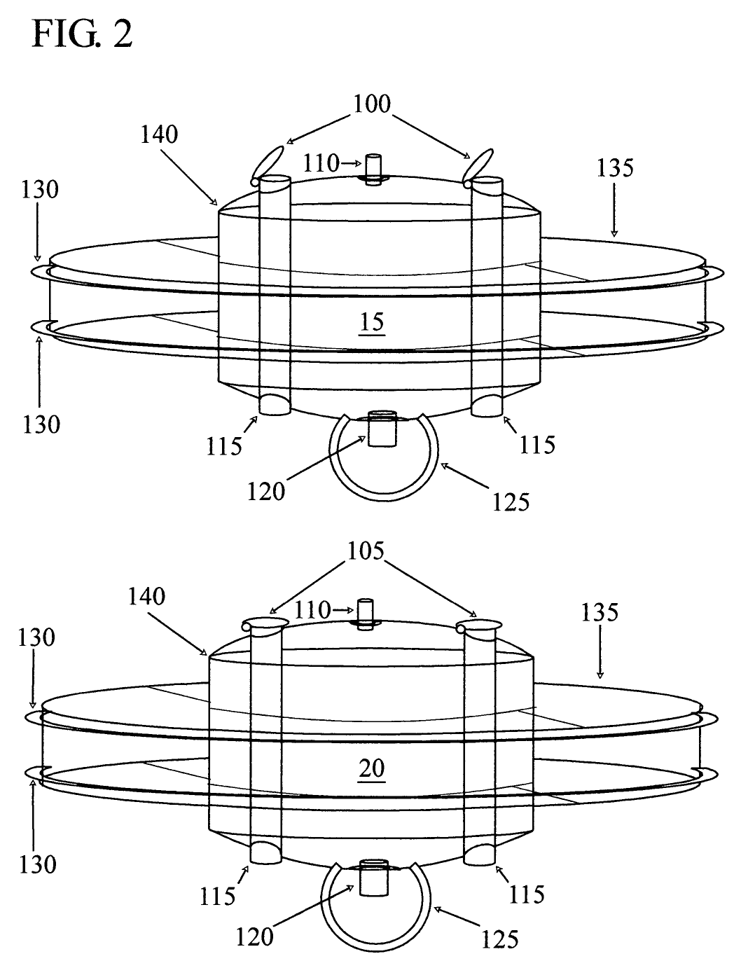

Turning to FIG. 2 there is shown buoyant chambers 15 and 20 in further detail. Both buoyant chambers 15 and 20 are identical except buoyant chamber 15 is shown with internal passage valves 100 in the open position and buoyant chamber 20 shows it's internal passage valves 105 in the closed position. Buoyant chambers 15 and 20 both show to have a chamber 140 for liquid and air or gas to transfer to and from each buoyant chamber. On the top side of chamber 140 shows an air or gas passage connection 110. On the bottom side of chamber 140 shows the liquid passage connection 120, also at the bottom of chamber 140 is towing ring 125 and internal passages 115. Surrounding chamber 140 is shown buoyant hub 135 that is used to stabilize the buoyant chamber from tipping and to give the buoyant chamber a weightless effect in liquid. And finally, around the sides of buoyant hub 135 are compression rings 130.

The following example is believed to be helpful in further illustrating the principles of the present invention. If reservoir 5 was an old rock quarry and is filled with fresh water and is 250 feet deep then the water pressure at the bottom would be 108.33 psi. So with that the buoyant chambers can be built to withstand at least twice that pressure so that they remain stable in shape and form, also high pressure hoses will be need to be used for gas and air passages, and a high pressure hose for the liquid passage as well. If the housing covers an area of 50 ft. by 100 ft. at the bottom of the quarry and extends 250 ft. to the top of the quarry and the useable buoyant chamber stroke is 200 ft. in total length of stroke, and the buoyant chamber diameter is 40 ft. equaling about 197,392 cubic feet of workable water minus the buoyant chamber displacement of 6,292 cubic feet leaving 191,100 cubic feet of workable water to use as working liquid during each stroke. Now say that each buoyant chamber weighs 30,000 lbs., so for a weightless effect the buoyant hub needs to have 480 cubic feet of hollow space for displacement. So now the only drag left is the 1,000 lbs. of drag that is created by the compression rings. Lets say 5,500 cubic feet of displacement is left after you minus all buoyant chamber materials including the buoyant hub and the internal passages, that's 343,200 lbs. in displacement left. Mix and match any turbine and generator to get the flow rate and head pressure that is needed, then figure out what size and type of penstock to use. By adjusting these dimensions it is easy to calculate the actual output of any turbine with a generator and how long each stroke will last before running the transfer pump again.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What I claim is:

1. An energy producing buoyancy pump comprising:
A reservoir being filled with a liquid;
a housing being submersed in said reservoir, said housing having an open bottom and a controlled passage at the top to admit liquid to become readily available for work;
a buoyant chamber positioned within said housing for a vertical stroke movement;
a means for connecting said buoyant chamber to another buoyant chamber to insure a reciprocating motion;
a passage for liquid to flow between said buoyant chambers;
a controlled internal passage in said buoyant chambers to admit the flow of liquid to fill the said housing on said buoyant chamber down stroke;
a controlled air or gas passage for transferring air or gas to and from said buoyant chamber to another said buoyant chamber on each stroke;
an air or gas transfer pump;
a means to regulate the operation of said transfer pump;
a means for working liquid to generate electric; and
a means to store electric;
whereby on each stroke of operation of said buoyancy pump, air or gas in said buoyant chamber at the top of it's stroke is transferred through said controlled air or gas passage by means of said air or gas transfer pump to another said buoyant chamber at the bottom of it's stroke thus in effect forcing said buoyant chamber's liquid to flow through said passage for liquid to said buoyant chamber at the top of it's stroke, at the same time said buoyant chamber at the bottom of it's stroke will begin to rise in said housing, forcing closed it's said controlled internal passage, causing the said controlled passage at the top of the said housing to open and liquid to be readily available for work, also at the same time the said buoyant chamber that is rising will be towing the other said buoyant chamber by means of a towline thus causing the said buoyant chamber at the top of it's stroke to descend and forcing open it's said internal controlled passage, all the while working-liquid is turning a turbine that turns a generator that generates electric that is being stored for the operation of a regulator that regulates said air or gas transfer pump's next use, and surplus electric is sent into a power line.
